(19) United States
(12) Patent Application Publication
(10) Pub. No.: US 2017/0293582 A1
(43) Pub. Date: Oct. 12, 2017

(54) CONNECTION DEVICE OF CONNECTOR FOR PORTABLE ELECTRONIC INSTRUMENT

(71) Applicant: Trinity, Inc, Nize-shi, Saitama (JP)

(72) Inventor: Tetsushi HOSHIKAWA, Niiza-shi, Saitama (JP)

(21) Appl. No.: 15/533,385

(22) PCT Filed: Dec. 24, 2014
(86) PCT No.: PCT/JP2014/084127

§ 371 Date: Jun. 6, 2017

(51) Int. Cl. G06F 13/40; H04M 1/725

(52) U.S. Cl. CPC G06F 13/409; H04M 1/72527

(57) ABSTRACT

A portable electronic instrument that has a connection port for inserting a connector and includes a built-in spring having a protrusion portion protruding in a lateral direction inside the connection port, a connector 10 has an insertion portion 12 which is inserted in the connection port 16 and includes connection members 31, 32 which respectively have hooking portions 23, 24 able to be hooked at the protrusion portions of the built-in springs inside a main body.

### BACKGROUND OF THE INVENTION

The present invention relates to a connection device for attaching and detaching a connector in a portable electronic instrument that has a connection port for inserting the connector and includes a built-in spring having a protrusion portion which protrudes in a lateral direction inside the connection port.

### DESCRIPTION OF RELATED ART

In a portable electronic instrument such as a multi-function mobile phone represented by a smart phone, connection is performed with respect to an external instrument by using a connection terminal, that is, a connector. As connection means of the connector, a connection port is provided on a side of the portable electronic instrument. When the connector is connected to the connection port, the portable electronic instrument is in a state of being connected electrically and mechanically. The ability of retaining the mechanical connection corresponds to a level to the extent that the connector does not instantly slip out in a state where the portable electronic instrument is suspended, and it may be possible to mention that the connection almost depends on friction acting on the connected portion. Beside, since no stopping mechanism is provided, when a force exceeding the frictional force of the connection acts, it is possible to easily presume that the connector is detached without much resistance.

For example, a technology of using only the frictional force can be found in JP-A-2005-065005. On the other hand, regarding a mechanism which does not allow a connection portion to simply detached, various types of countermeasures have been conducted in the related art. In a case where there is a structure in which the connection portion of the connector can be hooked on a side of the portable electronic instrument, a hook or the like is provided on the connector side by utilizing the structure, it is possible to comparatively and easily conduct falling prevention countermeasures. In contrast, recently, contrary to those in the related art, there have been provided portable electronic instruments including an uneven structure of being hooked on the connector side. A falling prevention structure of the type in the related art cannot be applied to the portable electronic instrument having such a structure. Therefore, there is a need to devise new countermeasures.

The aforementioned new portable electronic instrument includes a reception port for connecting the connector, and a pair of built-in springs which are disposed inside so as to pinch a part of the connector connected to the reception port and respectively have protrusion portions. The protrusion portions and the uneven structure engage with each other and the connector is sandwiched by the built-in spring. According to a survey of the technology in the related art having the aforementioned structure, the same or similar structure is not found. However, JP-A-2006-157982 is discovered as a connection example of the portable electronic instrument having a structure in which a target is pinched from both sides. The invention in JP-A-2006-157982 relates to an adaptor and includes a plurality of pairs of the ribs and locking claws in a portable telephone mounting portion of an adaptor main body. However, the new connection portion of the portable electronic instrument is extremely small. Therefore, it is considered to be excessively complicated to incorporate the structure having the plurality of pairs and to have no room spatially.

[PTL 1] JP-A-2005-065005

[PTL 2] JP-A-2006-157982

### BRIEF SUMMARY OF THE INVENTION

The present invention has been made in consideration of the foregoing circumstances, and an object thereof is to provide a connection device of a connector for a portable electronic instrument such that a portable electronic instrument which is not equipped with a hole for attaching a strap, or a hanging strap is prevented from dropping by allowing a strap, an accessory, or the like to be attached to the portable electronic instrument. In addition, another object of the present invention is to protect the portable electronic instrument from damage such as falling by using hooking means such that the connector is reliably connected even if the portable electronic instrument includes only an extremely small connection port. In addition, further another object of the present invention is to free the connector from a spring by utilizing only a built-in spring of the portable electronic instrument.

In order to solve the foregoing problems, according to the present invention, means is devised for a portable electronic instrument that has a connection port for inserting a connector and includes a built-in spring having a protrusion portion which protrudes in a lateral direction inside the connection port. The connector has an insertion portion which is inserted in the connection port of the portable electronic instrument, and includes a connection member which has a hooking portion able to be hooked at the protrusion portion of the built-in spring inside a main body. The connector is configured to include an operation member which is provided in the main body so as to be slidable in an insertion direction of the insertion portion in order to move the connection member in the lateral direction, an engagement member which is integrally provided with the operation member in order to convert a slide operation of the operation member into a movement of the connection member in the lateral direction, and a cam portion which is provided in the connection member so as to engage with the engagement member. The hooking portion is provided so as to be movable in the lateral direction, not to be hooked at the protrusion portion of the built-in spring when the insertion portion is inserted in the connection port, and to be hooked after passing through the protrusion portion.

As described above, a target of the present invention is the portable electronic instrument that has the connection port for inserting the connector and includes the built-in spring having the protrusion portion which protrudes in the lateral direction inside the connection port. The portable electronic instrument of such a type has a basic structure in which the insertion portion side of the connector is sandwiched by the built-in spring, and a sandwiching force from elastic action of the built-in spring included in the protrusion portion acts as a force of holding the connector. In a connection device of the connector according to the present invention, the connector is configured to be connected to the connection port and certain action is applied to the built-in spring, resulting in an elastic reaction force which causes a certain type of locking such that the connector is prevented from slipping out.

Therefore, according to the present invention, the connector has the insertion portion which is inserted in the connection port of the portable electronic instrument, and includes the connection member which has the hooking portion able to be hooked at the protrusion portion of the built-in spring inside the main body. The hooking portion is provided so as to be movable in the lateral direction, not to be hooked at the protrusion portion of the built-in spring when the insertion portion is inserted in the connection port, and to be hooked after passing through the protrusion portion. The hooking portion can be hooked at the built-in spring. However, hooking occurs in a case where an external force acts in a slip-out direction, and the hooking prevents the insertion portion from slipping out.

The connector is configured to include the operation member which is provided in the main body so as to be slidable in the insertion direction of the insertion portion in order to move the connection member in the lateral direction, the engagement member which is integrally provided with the operation member in order to convert a slide operation of the operation member into a movement of the connection member in the lateral direction, and the cam portion which is provided in the connection member so as to engage with the engagement member. After the connection member is inserted in an insertion port, the engagement member causes the cam portion to slide through a slide operation of the operation member. Accordingly, the hooking portion is widened outward in the lateral direction of the protrusion portion of the built-in spring, thereby being in a connection state as if the connection member is locked.

In the connection device of the present invention, when the connector is in a connection state with respect to the portable electronic instrument, a reaction force of the built-in spring is applied to the connection member, and the reaction force is pushed back in the opposite direction of the lateral direction. The connection member is in a state of pushing back the engagement member by the cam portion. The pushing-back force is also generated in the engagement member. However, the pushing-back force is in the lateral direction which is a direction substantially orthogonal to the slide direction of the operation member. Therefore, a tension state is retained up to the tip end of the hooking portion due to the pushing-back force. Thus, click feeling can be achieved and a locked state is retained.

Generally, there is provided a pair of right and left built-in springs. However, a structure in which only one side is the built-in spring and the other side has a slide structure can also be executed as a device of the present invention. That is, the connection member is formed with a pair of right and left opening/closing levers, and each of the opening/closing levers is configured to have the hooking portion at a tip end portion, to have the cam portion on a side of a base end portion, to have a fulcrum between the tip end portion and the base end portion, and to be able to pivot around the fulcrum.

In addition, the pair of right and left opening/closing levers has a bilaterally symmetrical shape including the hooking portions respectively provided at the tip end portions so as to be oriented toward the right and left sides and including the cam portions respectively provided on the right and left side surfaces of the base end portion side, and each of the cam portions can be configured on the base end portion side beyond the fulcrum provided between the tip end portion and the base end portion and to have a form in which the width in the lateral direction changes in a direction toward the fulcrum. In this case, a form in which the tip end portion moves when the engagement member is moved along the width changing form is realized.

The present invention is configured and acts as described above, thereby exhibiting an effect in which a strap, an accessory, or the like can be attached and the portable electronic instrument can be prevented from dropping, by being particularly applied to the portable electronic instrument which is not equipped with a hole for attaching a strap, or a hanging strap. In addition, according to the present invention, the portable electronic instrument is protected from damage such as falling by using hooking means such that the connector is reliably connected even if the portable electronic instrument includes only an extremely small connection port. Moreover, according to the present invention, the connector can be in a locked connection state by utilizing only the built-in spring of the portable electronic instrument, thereby exhibiting an effect in which the connector is free from a spring.

### BRIEF DESCRIPTION OF THE DRAWINGS

FIG. 1 is a perspective view illustrating an example of a connector for a portable electronic instrument, in which a connection device according to the present invention is applied.

FIG. 2 is a perspective view illustrating an example of a usage state of the device;

FIG. 3 is an exploded perspective view illustrating the device;

FIG. 4 is a longitudinal cross-sectional view of the internal structure of the connector device and;

FIG. 5 is a longitudinal sectional view illustrating the connection device when connected to the portable electronic instrument.

10 CONNECTOR

11 MAIN BODY

12 INSERTION PORTION

13 OPERATION MEMBER

14 STRAP ATTACHMENT PORTION

15 PORTABLE ELECTRONIC INSTRUMENT

16 CONNECTION PORT

17, 16 BUILT-IN SPRING

19, 20 PROTRUSION PORTION

21 SPRING BODY

22 OUTER WALL PART

23, 24 HOOKING PORTION

25, 26 INWARD CURVE PORTION

27, 28 CAM PORTION

29, 30 FULCRUM

31, 32 OPENING/CLOSING LEVERS (CONNECTION MEMBER)

33 STRINGER

34 MEMBER

35, 36 SPINDLE

37, 38 ENGAGEMENT MEMBER

39 OPENING

40, 41 TWO MEMBERS CONFIGURING MAIN BODY

42 FITTING MEANS

43 FITTING MATE

44 FLANGED LOCKING PORTION

45 FIXING PORTION

46 STRAP ATTACHMENT PORTION

47 STRAP

### DETAILED DESCRIPTION OF THE INVENTION

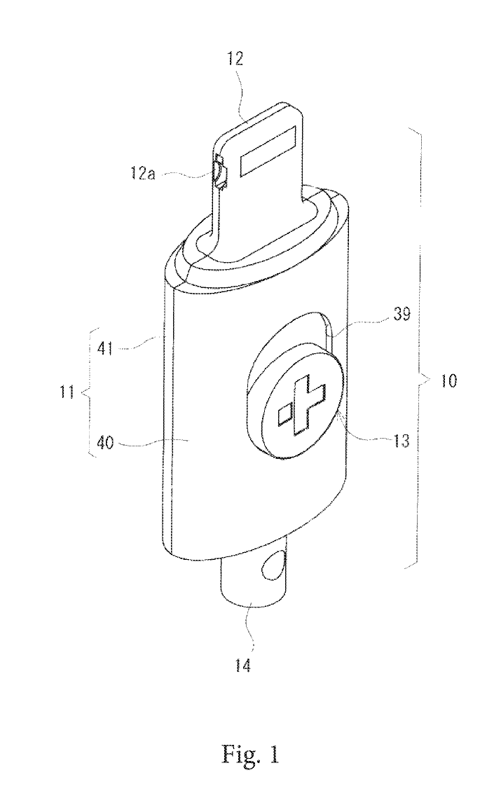

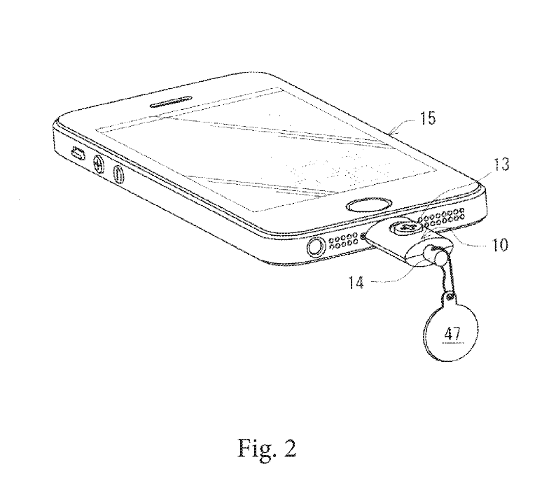

With reference to an embodiment illustrated below, the present invention will be described in more detail. FIG. 1 illustrates the appearance of a connector 10 in which a connection device according to the present invention is applied. FIG. 1 includes a main body 11 of the connector, an insertion portion 12, an operation member 13, and a strap attachment portion 14. The main body 11 is configured to have two members 40, 41 in the front and the rear (or foreside and backside). FIG. 2 illustrates iPhone (brand name) as a portable electronic instrument 15, and the connector 10 is for Lightning Connector (brand name) included in the portable electronic instrument 15.

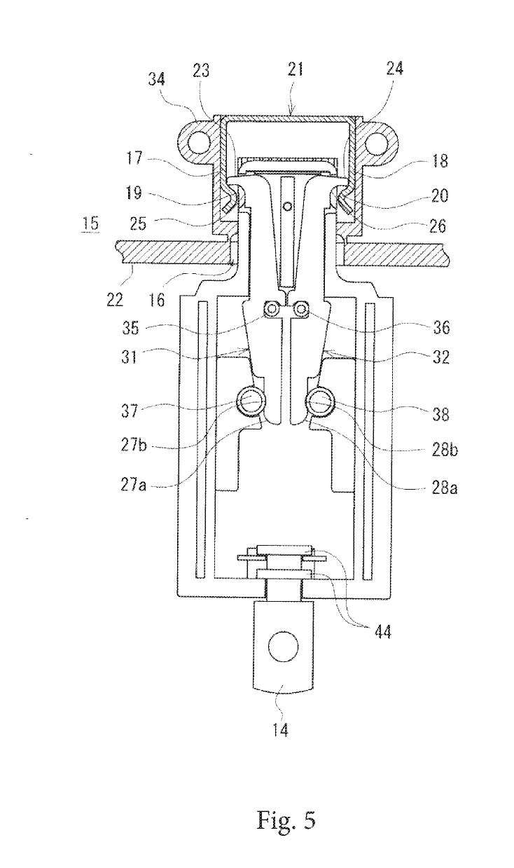

The connector 10 according to the present invention is connected to the portable electronic instrument 15, and a connection state is illustrated in FIG. 5 in detail. The portable electronic instrument 15 of the embodiment is configured to include a connection port 16 and right and left built-in springs 17, 18 which are disposed so as to pinch a part of the connector 10 (specifically, the below-described insertion portion 12) connected to the connection port 16 (FIG. 5), and the built-in springs 17, 18 respectively have protrusion portions 19, 20. A spring body 21 itself is fixed to a member 34, and the member 34 is attached to the inside of the connection port 16 which is open at an outer wall part 22 of the portable electronic instrument 15.

A pair of the built-in springs 17, 16 in the illustrated example is formed as a portion of the spring body 21 having a substantially Ω-shaped front surface shape. Both end portions having bilaterally symmetric shapes shapes are oriented toward the connection port 16, and the protrusion portions 19, 20 are provided near the end portions. The protrusion portions 19, 20 are disposed so as to face each other in a lateral direction and protrude toward the center of the spring body 21. A pair of the protrusion portions 19, 20 has an uneven structure forming a shape in which a part protrudes inward (convex shape) and a part on an inner side (deep side) of the protrusion portions 19, 20 is recessed (concave shape). The present invention utilizes the uneven structure as a portion of the connection device of the connector.

The connection device of the present invention is inserted in the portable electronic instrument 15 through the connection port 16 and includes a connection member to be connected, inside the main body. The connection member includes the insertion portion 12 and hooking portions 23, 24 which can be hooked at the protrusion portions 19, 20 of the pair of built-in springs 17, 18. The connection member has a basic configuration in which the hooking portions 23, 24 are movable in the lateral direction so as not to be hooked at the protrusion portions 19, 20 of the built-in springs 17, 18 when the insertion portion 12 is inserted in the connection port 16, and to be hooked after passing through the protrusion portions 19, 20. The expression “being hooked” denotes a state of not being able to be detached as it stands.

In the case of the embodiment, the connection member is configured to include a pair of right and left opening/closing levers 31, 32. The pair of opening/closing levers 31, 32 has the hooking portions 23, 24 at tip end portions thereof and has cam portions 27, 28 on a side of base end portions. The pair of opening/closing levers 31, 32 has fulcrums 29, 30 at arbitrary positions between the tip end portions and the base end portions and is configured to be able to pivot around the fulcrums 29, 30. The hooking portions 23, 24 are at the tip end portions of the opening/closing levers 31, 32 and protrude to the right and left sides within a range of the insertion portion 12 so as to form inward curve portions 25, 26 allowing the protrusion portions 19, 20 to be housed, thereby forming the substantially L-shaped tip end portions.

The hooking portions 23, 24 protrude to the sides beyond the range of the insertion portion 12 due to an operation of a slide button 13 which is an operation member. Therefore, small openings 12a, 12b are formed on both the right and left sides of the insertion portion 12. Portions below the inward curve portions 25, 26 extend in a direction toward the fulcrums 29, 30 via crank portions 25a, 26a, and each of the back surface comes into contact with a stringer 33 at a central portion in a state where the opening/closing levers 31, 32 are closed. The fulcrums 29, 30 are configured to engage with spindles 35, 36 attached to the main body 11 such that the opening/closing levers 31, 32 can pivot. The fulcrums 29, 30 are formed so as to have cut forms inclined downward toward the central portion and also serve as one type of means biasing the opening/closing levers 31, 32 in a closing direction.

The connection device of the present invention is configured to include the operation member 13 which is provided in the main body 11 so as to be slidable in an insertion direction (referred to as vertical direction) of the insertion portion 12 in order to move the connection member in the lateral direction, and engagement members 37, 38 which are integrally provided with the operation member 13 in order to convert a movement of the operation member 13 in the vertical direction into a movement of the connection member in the lateral direction, and the above-described cam portions 27, 28 which are provided in the connection member so as to engage with the engagement members 37, 38.

The operation member 13 is provided so as to be movable in the vertical direction in an opening 39 which is a long hole in the vertical direction formed in the member 40, that is, one of the two members 40, 41 configuring the main body 11. The illustrated operation member 13 includes a base portion 13b which is disposed on the inner surface of the member 40 on one side, and a protrusion portion 13a which is provided in a convex shape on the outer surface thereof. The operation member 13 has a structure in which the protrusion portion 13a is exposed to the outside through the opening 39 and the engagement members 37, 38 are attached to the inner surface of the base portion 13b.

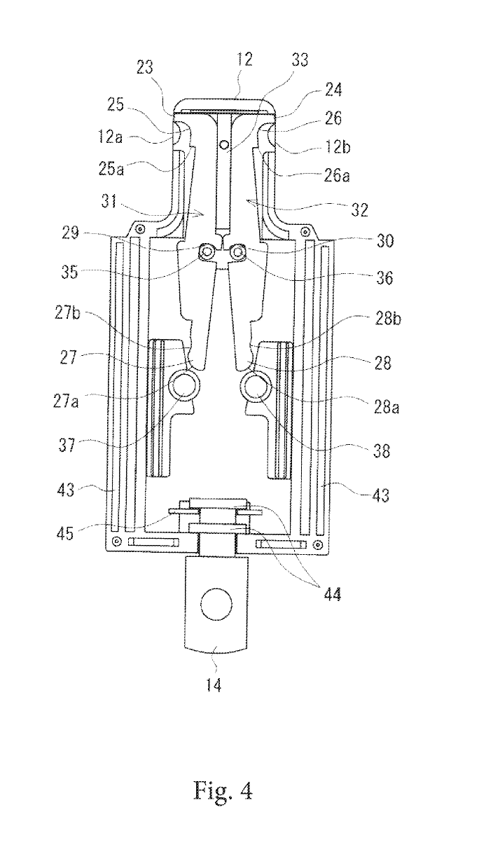

In a state where the opening/closing levers 31, 32 are closed, the cam portions 27, 28 are respectively provided with gaps so as to be able to engage with the engagement members 37, 38 (refer to FIG. 4). In the cam portions 27, 28, curved surfaces which close the base end portions of the opening/closing levers 31, 32 by engaging with the engagement members 37, 38 are formed. The curved surfaces have parts 27a, 28a which become curved surfaces convex outward from the central portion, and have parts 27b, 28b which become curved concave surfaces closing the opening/closing levers 31, 32 at, the base end portions by engaging with the engagement members 37, 38, and retaining the opening/closing levers 31, 32 in an open state at the tip end portions (refer to FIG. 5).

As for the size of the connector 10 according to the present invention, the external size of each of the hooking portions 23, 24 is approximately 0.5×2.5 mm. The width of each of the opening/closing levers 31, 32 is approximately 3 mm and the length thereof is a little over 16 mm. In regard to the insertion portion 12 illustrated in FIG. 1, the width is approximately 6 mm, the height is approximately 8 mm, and the overall length to the strap attachment portion 14 is a little less than 30 mm. In this manner, it is understood that the device of the present invention belongs to the field of precise processing technology.

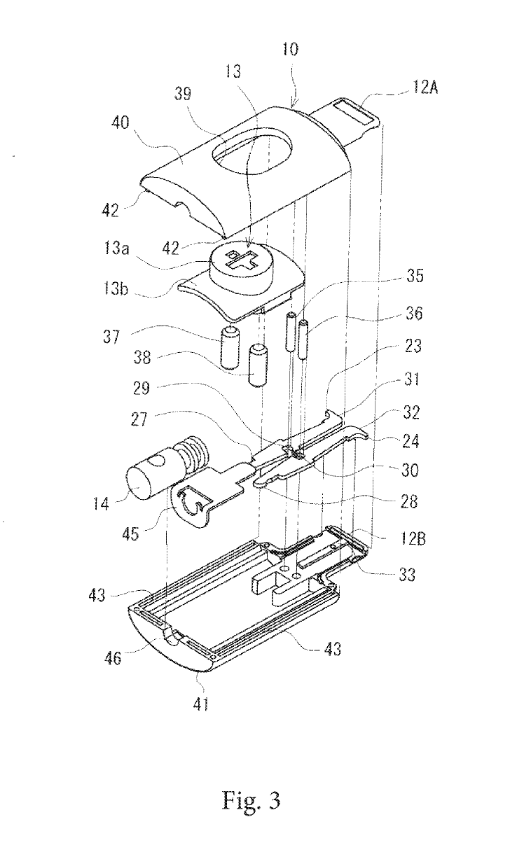

The main body 11 illustrated as the embodiment is formed with the two front and rear members 40, 41 illustrated in FIG. 3 in detail. Each of the two members 40, 41 is provided through plastic molding and has a structure in which the connection member, and a member and a mechanism for operating the connection member are assembled inside thereof. The two members 40, 41 have fitting means 42 formed to be a convex portion and a fitting mate 43 formed to be a concave portion which are fitted to each other. The two members 40, 41 are integrally combined together through the fitting. Tip end portions 12A, 12B of the two members are integrally combined together, thereby configuring the insertion portion 12.

In the connection device of the present invention, in the connector 10, the insertion portion 12 is provided on one end side of the main body 11 so as to be the connection side with respect to the portable electronic instrument 15, and the strap attachment portion 14 is provided at a position opposite to the main body 11. The attachment portion 14 is attached to a fixing portion 45 attached to the inside of the main body 11, and is attached to a strap attachment portion 46 by flanged locking portions 44, 44 which are provided on one end side thereof in two lines. The connector 10 of the present invention and the strap attachment portion 14 are attached to each other through such a dual locking structure. Therefore, even in the event where the main body 11 is split, the strap attachment portion 14 still remains being locked by the fixing portion 45, and the strap attachment portion 14 is prevented from falling. In the illustrated example, the attachment portion 14 is attached to the main body 11 so as to be able to pivot, and a strap 47 can be attached to the attachment portion 14.

Since the connection device of a connector for a portable electronic instrument according to the present invention is configured as described above, the operation member 13 is operated to slide in a direction toward the base end portion such that the opening/closing levers 31, 32 are at closed positions. Then, the insertion portion 12 of the connector 10 is inserted in the connection port 16 of the portable electronic instrument 15. In this manner, the hooking portions 23, 24 at the tip ends of the opening/closing levers 31, 32 can enter the innermost portion of the spring body 21 without much resistance. Subsequently, when the operation member 13 is operated to slide in a direction toward the tip end portion, the tip end portions of the opening/closing levers 31, 32 act so as to open due to the cam-engagement of the engagement members 37, 38 and the cam portions 27, 28. Therefore, the hooking portions 23, 24 enter the concave structure deep inside the protrusion portions 19, 20 of the built-in springs 17, 18, and the opening/closing levers 31, 32 pinch the protrusion portions 19, 20. In addition, on the base end portion side, the engagement members 37, 38 move so as to engage with the parts 27b, 28b of the curved concave surfaces. At the same time, it is possible to achieve click feeling (FIG. 5), The built-in springs 17, 18 act as an elastic reaction force for the pinching thereof and are in a state of being locked due to the elastic reaction force.

In order to release the connector 10 from the coupled state, the operation portion 13 is caused to slide in the direction toward the base end portion, and the width between the hooking portions 23, 24 is narrowed within the width of the insertion portion 12. Thereafter, the connector 10 may be pulled out. According to the present invention having such a configuration, the connected connector 10 does not simply detached from the portable electronic instrument 15. In addition, the strap 47 can be attached to the connector 10 in a manner described above. Thus, on the contrary, the portable electronic instrument 15 can be prevented from falling off from the strap 47.

1. A connection device of a connector for a portable electronic instrument that has a connection port for inserting the connector and includes a built-in spring having a protrusion portion which protrudes in a lateral direction inside the connection port,
wherein the connector has an insertion portion which is inserted in the connection port of the portable electronic instrument, and includes a connection member which has a hooking portion able to be hooked at the protrusion portion of the built-in spring inside a main body, and
wherein the connector is configured to include an operation member which is provided in the main body so as to be slidable in an insertion direction of the insertion portion in order to move the connection member in the lateral direction, an engagement member which is integrally provided with the operation member in order to convert a slide operation of the operation member into a movement of the connection member in the lateral direction, and a cam portion which is provided in the connection member so as to engage with the engagement member.

2. The connection device of a connector for a portable electronic instrument according to claim 1,
wherein the connection member is formed with a pair of right and left opening/closing levers, and each of the opening/closing levers is configured to have the hooking portion at a tip end portion, to have the cam portion on a side of a base end portion, to have a fulcrum between the tip end portion and the base end portion, and to be able to pivot around the fulcrum.

3. The connection device of a connector for a portable electronic instrument according to claim 1,
wherein the pair of right and left opening/closing levers has a bilaterally symmetrical shape including the hooking portions respectively provided at the tip end portions so as to be oriented toward the right and left sides and including the cam portions respectively provided on the right and left side surfaces of the base end portions, and each of the cam portion is configured to be on the base end portion side beyond the fulcrum provided between the tip end portion and the base end portion and to have a form in which the width is the lateral direction is widened in a direction toward the fulcrum.
